(19) United States
(12) Patent Application Publication
(10) Pub. No.: US 2025/0193723 A1
(43) Pub. Date: Jun. 12, 2025

(54) CHANNEL STATE INFORMATION CONFIGURATION

(71) Applicant: ZTE Corporation, Shenzhen (CN)

(72) Inventors: Xiaoying MA, Shenzhen (CN); Bo DAI, Shenzhen (CN); Mengzhu CHEN, Shenzhen (CN); Jun XU, Shenzhen (CN); Hong TANG, Shenzhen (CN); Qiujin GUO, Shenzhen (CN); Xuan MA, Shenzhen (CN)

(21) Appl. No.: 19/056,014

(22) Filed: Feb. 18, 2025

Related U.S. Application Data
(63) Continuation of application No. PCT/CN2023/075522, filed on Feb. 10, 2023.

(51) Int. Cl. H04W 24/10; H04B 7/06; H04L 5/00

(52) U.S. Cl. CPC H04W 24/10; H04B 7/0626; H04L 5/0051

(57) ABSTRACT

Systems, methods, and apparatus for wireless communication are described. A wireless communication method includes receiving, by a wireless device, a combined channel state information (CSI) report configuration including a resource for channel measurement, where the resource for channel measurement includes one or more CSI resource configurations. The method further includes transmitting, by the wireless device, a combined CSI report based on the combined CSI report configuration. The described techniques may be adopted by a network device or by a wireless device.

This application is a continuation and claims priority to International Application No. PCT/CN2023/075522, filed on Feb. 10, 2023, the disclosure of which is hereby incorporated by reference herein in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for configuring combined channel state information (CSI) reports. A combined CSI report includes a group of CSI reports.

A first example wireless communication method includes receiving, by a wireless device, a combined channel state information (CSI) report configuration including a resource for channel measurement, where the resource for channel measurement includes one or more CSI resource configurations. The method further includes transmitting, by the wireless device, a combined CSI report based on the combined CSI report configuration.

A second example wireless communication method includes transmitting, by a network device, a combined channel state information (CSI) report configuration including a resource for channel measurement, where the resource for channel measurement includes one or more CSI resource configurations. The method further includes receiving, by the network device, a combined CSI report based on the combined CSI report configuration.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary channel state information (CSI) report configuration. FIGS. 2-5 illustrate exemplary port indexing schematics.

FIG. 6 illustrates an exemplary CSI report configuration with a list of numbers of ports and a list of codebook configurations.

FIG. 7 illustrates an exemplary CSI report configuration with a CSI resource configuration.

FIG. 8 illustrates an exemplary CSI reference signal (CSI-RS) resource with a list of resource mappings.

FIG. 9 illustrates an exemplary CSI reference signal (CSI-RS) resource with a list of codebook configurations.

FIG. 10 illustrates an exemplary CSI report configuration with a resource for channel measurement.

FIG. 11 is an exemplary flowchart for transmitting a combined CSI report.

FIG. 12 is an exemplary flowchart for receiving a combined CSI report.

FIG. 13 illustrates an exemplary block diagram of a hardware platform that may be a part of a network device or a communication device.

FIG. 14 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Compared to conventional wireless system, a greater bandwidth and multiple antennas are used in 5G communication systems. The large number of spatial elements cause a large power consumption.

To reduce the power consumption of gNB, one potential method is reducing the number of antennas or antenna ports. The change of number of antennas or antenna ports may have impact on UE CSI measurement or CSI reporting. Therefore, in this patent, a new method of CSI measurement or CSI reporting based on different antenna ports is proposed.

CSI (channel state information) measurement: UE (user equipment) shall perform measurements based on CSI-RS (reference signal) and may report corresponding report to gNB.

A NZP-CSI-RS-Resource includes a qcl-InfoPeriodicCSI-RS. The qcl-InfoPeriodicCSI-RS indicates a TCI-StateId. The TCI-StateId is associated with a TCI-State. This information indicates a beam information for the CSI-RS.

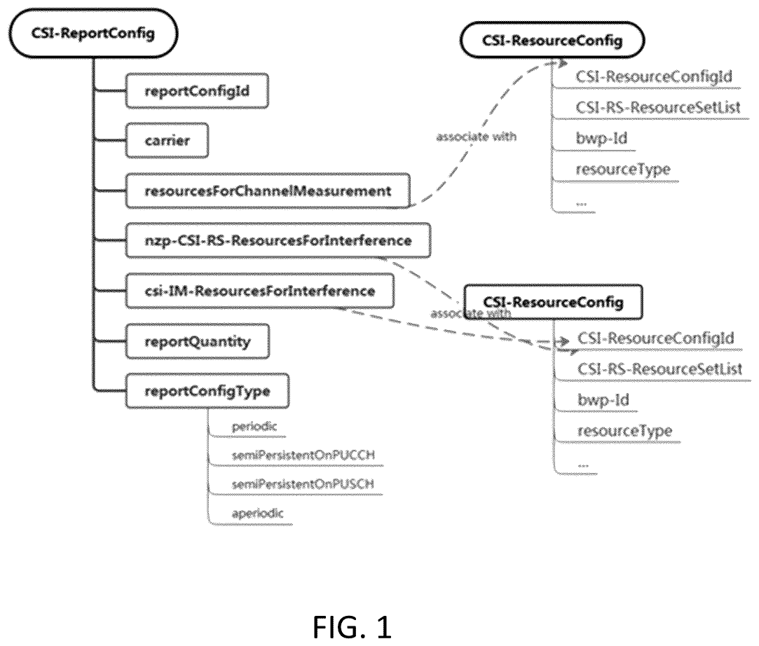

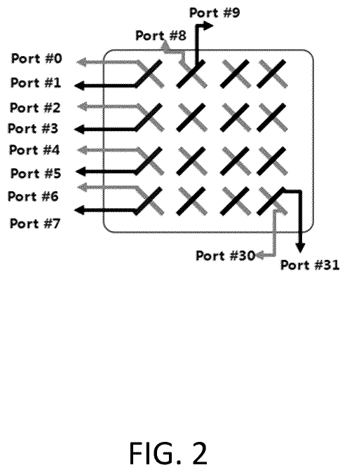

As shown in FIG. 1, a UE can be configured with one or more CSI report configuration by CSI-ReportConfig signaling. The CSI-ReportConfig will associate with one or more CSI-RS resource setting by CSI-resourceConfigID. The CSI-RS resource setting is configured by CSI-ResourceConfig signaling.

codebookConfig is also configured in a CSI-ReportConfig. codebookConfig is a signaling about Codebook configuration for Type-1 or Type-2 codebook, and includes codebook subset restriction. CodebookConfig includes one or two Codebook subset restriction for one CSI-ResourceConfig. The number of ports should be the same if two Codebook subset restrictions are configured in one CodebookConfig signaling. If two codebook subset restriction are configured, each codebook subset restriction is used for one resource group. One resource group is for one TRP (Transmission and reception point).

In one CSI-ReportConfig, ResourceForChannelMeasurement can associate with only one CSI-ResourceConfig.

In Release 17, in a CodebookConfig, for TypeI-SinglePanel codebook, two RI restrictions and two codebook subset restrictions can be configured. The two codebook subset restrictions are used for two different CMR (channel measurement resource) groups. Two RI restrictions are used for different types. In some embodiments, one RI restriction is used for multi-TRP, and the other is used for single-TRP.

```
    CodebookConfig-r17 ::= SEQUENCE {
        typeI-SinglePanel-Group1-r17 SEQUENCE {
        typeI-SinglePanel-Group2-r17 SEQUENCE {
        typeI-SinglePanel-ri-RestrictionSTRP-r17 BIT STRING (SIZE
(8)) OPTIONAL, -- Need R
        typeI-SinglePanel-ri-RestrictionSDM-r17 BIT STRING (SIZE
(4)) OPTIONAL -- Need R
      }
```

In Release 17, In a CSI-report, UE can report N (N>=1) pairs/groups and M (M>1) beams per pair/group, different beams within a pair/group can be received simultaneously.

The time domain behavior of the CSI-RS resources within a CSI Resource Setting are indicated by the higher layer parameter resource Type and can be set to aperiodic, periodic, or semi-persistent. For periodic and semi-persistent CSI Resource Settings, when the UE is configured with groupBasedBeamReporting-r17, the number of CSI Resource Sets configured is S=2, each CSI resource set is for one TRP, otherwise the number of CSI-RS Resource Sets configured is limited to S=1.

The number of ports of a CSI-RS is configured by nrofPorts in CSI-ResourceMapping, CSI-ResourceMapping is associated with a NZP-CSI-RS-Resource. NZP-CSI-RS-Resource is associated with a NZP-CSI-RS-ResourceSet. A NZP-CSI-RS-Resource is associated with a CSI-ResourceConfig. A CSI-ResourceConfig is associated with a CSI-ReportConfig. The nrofPorts can be one of the following: p1 (1 port), p2, p4, p8, p12, p16, p24, p32.

In this patent, power offset corresponds to powerControlOffset or powerControlOffsetSS. In this patent, number of ports means number of CSI-RS ports.

powerControlOffset: which is the assumed ratio of PDSCH EPRE to NZP CSI-RS EPRE when UE derives CSI feedback and takes values in the range of [−8, 15] dB with 1 dB step size.

powerControlOffsetSS: which is the assumed ratio of NZP (Non-zero power) CSI-RS EPRE to SS/PBCH block EPRE (Energy per resource element)).

If the number of base station antennas changes, the channel may be changed. It is helpful if UE can provide channel measurement of different antenna port numbers. In prior art, most CSI-RS resource configuration and CSI report configurations are configured by RRC (Radio Resource Control) signaling. Usually, one CSI-ReportConfig associate with a CSI-ResourceConfig with one number of port. That is, one CSI report only includes the report about one number of port. If UE needs to report CSI for multiple numbers of ports, UE should report multiple CSI in multiple CSI reporting and each CSI reporting includes a report about one number of port. One CSI reporting needs one configuration of CSI-ReportConfig. Therefore, this method needs multiple CSI-ReportConfig signaling. Since the number of CSI-ReportConfig is limited for one BWP, configure multiple CSI-ReportConfig to report CSI for multiple number of ports is inappropriate.

In this patent, a method that UE reports in a single reporting instance multiple CRI, RI, CQI, LI (Layer Indicator), L1-RSRP (Layer 1 reference signal received power), L1-SINR (signal-to-interference and noise ratio), or PMI for multiple numbers of ports which are associated with a report configuration is provided.

### II. Embodiment 1

### Framework

At UE side, the following operations may be performed:

Receiving, a RRC signaling, the RRC signaling includes at least a CSI report configuration and a CSI resource configuration. The CSI report configuration is associated with more than one resource. The more than one resource is associated with more than one resource category. Each resource category can be associated with one or more resources. The CSI report configuration corresponds to a combined CSI report configuration.

Performing, CSI report according to the RRC signaling. The reports for every resource category are reported in one CSI reporting. Each report is generated according to one resource category. In some embodiments, CSI report corresponds to a combined CSI report.

In some embodiments, the CSI report configuration is associated with one or more resources. The resources are associated with one or more resource categories.

Resource category includes at least one of the following: number of ports associated with a CSI-RS resource, power offset associated with a CSI-RS resource, TCI (transmission configuration indicator) state associated with a CSI-RS resource, or index or group index associated with a CSI-RS resource.

### Configuration Information

In some embodiments, the CSI report configuration is associated with one or more resources. The resources are associated with one resource category. The resource category is a first number of ports.

UE generates CSI report based on the measurement on CSI-RS configured with a first number of ports. To make UE report multiple CSI for different numbers of ports or different resource categories in one CSI reporting, some report parameters may be configured. The report parameters are used to select parts of CSI-RS ports from a CSI-RS resource configured with a first number of ports. UE uses the selected parts of CSI-RS ports to generate a CSI report of another resource category.

1. UE may receive a high layer signaling. The high layer signaling may be a MAC CE signaling or a RRC signaling. The high layer signaling includes at least one of the following: multiple CSI report indication, a number of reports in one CSI reporting indication, a maximum number of a reports in one CSI reporting indication, a CSI report configuration, a CSI resource configuration. (In some embodiments, a CSI report configuration corresponds to a CSI-ReportConfig, a CSI resource configuration corresponds to a CSI-ResourceConfig.)

In some embodiments, a RRC signaling includes a report parameter and a combined CSI report configuration. The report parameter includes at least one of the following: a beam parameter, a number of ports list, a power offset list, a factor list, a port indication list, a number of reports, or a mapping parameter.

In some embodiments, the report parameter is configured in the combined CSI report configuration.

In some embodiments, a combined CSI report configuration is associated with one CSI-RS resource. gNB transmits one CSI-RS that is based on the CSI-RS resource. In some embodiments, UE reports a combined CSI report that includes one or more CSI reports based on at least the CSI-RS.

In some embodiments, the combined CSI report includes one or more CSI reports. Each of the CSI reports in the combined CSI report is based on a same CSI-RS resource and/or the report parameter.

In some embodiments, the beam parameter indicates at least one of the following: azimuth of a beam, tilt of a beam, horizontal beam width, vertical beam width, or horizontal azimuth.

In some embodiments, a RRC signaling includes a report parameter and a combined CSI report configuration. The combined CSI report configuration is associated with a CSI-RS resource configured with a first number of ports. The UE is also configured with one or more beam parameters, each beam parameter being associated with a number of ports. The UE may also be configured with a number of ports list indicating which kind of CSI reports needs to be reported. In some embodiments, the first number of ports is the largest number of ports among the numbers of ports configured in the CSI-RS resource and the numbers of ports associated with beam parameters. In some embodiments, the first number of ports is the largest number of ports among the numbers of ports configured in the number of ports list.

For example, a UE is configured with a combined CSI report configuration. The combined CSI report configuration is associated with a CSI-RS resource configured with a first number of ports and a beam parameter of a second number of ports. For example, a first number of ports is 32, and a second number of ports is 8. The UE needs to report CSI reports of 32 ports and 8 ports in a combined CSI report. The CSI report of 32 ports is based on the CSI-RS resource configured with 32 ports. The CSI report of 8 ports is based on part of the CSI-RS resource configured with 32 ports and the beam parameter of 8 ports.

The number of ports list indicates CSI report of which number of ports should be reported in the combined CSI report. For example, the number of ports list is {B1,B2,B3}. UE needs to report a combined CSI report including CSI report of B1 number of ports, CSI report of B2 number of ports, and CSI report of B3 number of ports. For example, the number of ports list is {32,16,8}. UE reports a combined CSI report. The combined CSI report includes CSI report of 32 ports, CSI report of 16 ports, and CSI report of 8 ports. In some embodiments, each CSI report is associated with a different CSI-RS resource. In some embodiments, each CSI report is associated with the same CSI-RS resource.

The power offset list indicates CSI report of which power offset should be reported in the combined CSI report. For example, power offset list is {A1,A2,A3}. UE reports a combined CSI report. The combined CSI report includes CSI report of Al power offset, CSI report of A2 power offset, and CSI report of A3 power offset. In some embodiments, each CSI report is associated with a different CSI-RS resource. In some embodiments, each CSI report is associated with the same CSI-RS resource.

The factor list is used to determine CSI report of which number of ports should be reported in the combined CSI report. For example, a combined CSI report configuration is associated with a CSI-RS resource with a first number of ports (e.g., K ports) and a factor list {K1,K2,K3}. The factor in the factor list is used to determine a second number of ports by dividing the first number of ports by the factor. In this example, UE reports a combined CSI report. The combined CSI report includes CSI report of K/K1 ports, CSI report of K/K2 ports, and CSI report of K/K3 ports. For example, a combined CSI report configuration is associated with a CSI-RS resource with 32 ports and a factor list {1,2,4}. UE reports a combined CSI report. The combined CSI report includes CSI report of 32/1=32 ports, CSI report of 32/2=16 ports, and CSI report of 32/4=8 ports. In some embodiments, each CSI report is associated with a different CSI-RS resource. In some embodiments, each CSI report is associated with the same CSI-RS resource. For another example, the factor in the factor list is a fraction number. Or the factor in the factor list is a decimal. The factor is a value greater than or equal to 0 and less than or equal to 1. The factor is used to be multiplied by a value of number of ports. For example, a combined CSI report configuration is associated with a CSI-RS resource with a first number of ports (e.g., K ports) and a factor list {K1,K2,K3}. The factor in the factor list is used to determine a second number of ports by multiplying the first number of ports by the factor. In this example, UE reports a combined CSI report. The combined CSI report includes CSI report of K*K1 ports, CSI report of K*K2 ports, and CSI report of K*K3 ports. For example, a combined CSI report configuration is associated with a CSI-RS resource with 32 ports and a factor list {1,1/2,1/4}. UE reports a combined CSI report. The combined CSI report includes CSI report of 32*1=32 ports, CSI report of 32*1/2=16 ports, and CSI report of 32*1/4=8 ports. In some embodiments, each CSI report is associated with a different CSI-RS resource. In some embodiments, each CSI report is associated with the same CSI-RS resource.

The port indication list indicates one or more port indications. Each port indication indicates one or more port indexes. For example, a combined CSI report configuration is associated with a CSI-RS resource with 32 ports and a port indication list {{0,1,2,3}, {0,1,2,3,4,5,6,7}, and {0,1,2,3,4 . . . ,31}}. UE reports a combined CSI report. The combined CSI report includes CSI report of 32 ports (CSI-RS with port index {0,1,2,3,4 . . . ,31}), CSI report of 8 ports (CSI-RS with port index {0,1,2,3,4,5,6,7}), and CSI report of 4 ports (CSI-RS with port index {0,1,2,3}).

The number of reports indicates the number of CSI reports in a combined CSI report. For example, a UE is configured with a combined CSI report configuration and a number of reports (e.g., 4, 3,,2, 1, 5, 6, 7, 8). The combined CSI report configuration is associated with more than one CSI-RS resource. UE reports the best 4 CSI reports in the combined CSI report according to the CSI-RS resources. For another example, a UE is configured with a combined CSI report configuration and a number of reports (e.g., 4). The combined CSI report configuration is associated with one CSI-RS resource and more than one report parameter. The more than one report parameter is used for CSI report of other numbers of ports. UE reports the best 4 CSI reports in the combined CSI report according to the CSI-RS resources and report parameters.

In some embodiments, only a number of ports is indicated. UE should know which ports are used. For example, UE is only indicated that the UE should report a CSI report of 8 ports and a CSI report of 32 ports. But the UE is configured with only a CSI-RS resource of 32 ports. Then UE does not know which 8 ports of the 32 ports should be used for the CSI report of 8 ports. To determine which ports should be used/selected, the ports are determined based on a predefined information or a signaling. In some embodiments, the predefined information includes at least one of the following: from low index to high index, from high index to low index, or port index {0, 0+X, 0+2X, . . . }.

In some embodiments, N1, N2 is used to indicate or determine the number of antenna ports in horizontal and vertical directions. The number of ports of a CSI-RS is equal to N1*N2*2. The N1*N2*2 antennas compose an antenna array. Each port corresponds to one antenna element. In some embodiments, N1, N2 is used to indicate or determine the number of antenna ports in first and second directions.

In some embodiments, the predefined information includes at least an order of port index {0,1,1*N2*2,1*N2*2+1, . . . , (N1−1)*N2*2, (N1−1)*N2*2+1,

$$2 * 1 , 2 * 1 + 1 * N 2 * 2 + 2 * 1 , 1 * N 2 * 2 + 2 * 1 + 1 , … , ( N 1 - 1 ) * N 2 * 2 + 2 * 1 , ( N 1 - 1 ) * N 2 * 2 + 2 * 1 + 1 , … , 2 * ( N 2 - 1 ) , 2 * ( N 2 - 1 ) + 1 , 2 * ( N 2 - 1 ) + 1 * N 2 * 2 , 2 * ( N 2 - 1 ) + 1 * N 2 * 2 + 1 , … , 2 * ( N 2 - 1 ) + ( N 1 - 1 ) * N 2 * 2 , 2 * ( N 2 - 1 ) + ( N 1 - 1 ) * N 2 * 2 + 1 \} .$$

For example, selecting 8 ports from 32 ports (e.g., N1=4, N2=4), the port index is {0,1,8,9,16,17,24,25}.

In some embodiments, the predefined information includes at least an order of port index {0,1,1*N1*2,1*N1*2+1, . . . , (N2−1)*N1*2, (N2−1)*N1*2+1,

$$2 * 1 , 2 * 1 + 1 , 1 * N 1 * 2 + 2 * 1 , 1 * N 1 * 2 + 2 * 1 + 1 , … , ( N 2 - 1 ) * N 1 * 2 + 2 * 1 , ( N 2 - 1 ) * N 1 * 2 + 2 * 1 + 1 , … , 2 * ( N 1 - 1 ) , 2 * ( N 1 - 1 ) + 1 , 2 * ( N 1 - 1 ) + 1 * N 1 * 2 , 2 * ( N 1 - 1 ) + 1 * N 1 * 2 + 1 , … , 2 * ( N 1 - 1 ) + ( N 2 - 1 ) * N 1 * 2 , 2 * ( N 1 - 1 ) + ( N 2 - 1 ) * N 1 * 2 + 1 \} .$$

For example, selecting 8 ports from 32 ports (e.g., N1=4, N2=4), the port index is {0,1,8,9,16,17,24,25}.

In some embodiments, the predefined information includes at least an order of port index {0, N1*N2, 0+X, N1*N2+X, 0+2X, N1*N2+2X, . . . }. For example, selecting 8 ports from 32 ports (e.g., N1=4, N2=4), the port index is {0,16,4,20,8,24,12,28}.

In some embodiments, the predefined information includes at least an order of port index {0, N1*N2, 1, N1*N2+1, 2, N1*N2+2, . . . }. For example, selecting 8 ports from 32 ports (e.g., N1=4, N2=4), the port index is {0,16,1,17,2,18,3,19}.

For example, the predefined information can be from low index to high index. Then the 8 ports are indicated by the port index {0,1,2,3,4,5,6,7} of the 32 ports CSI-RS.

For example, the predefined information can be from high index to low index. Then the 8 ports are indicated by the port index {31,30,29,28,27,26,25,24} of the 32 ports CSI-RS.

For example, the predefined information can be port index {0, 0+X, 0+2X, . . . }. Then to find the 8 ports from the 32 ports, X=32/8=4, the 8 ports are indicated by the port index {0,4,8,12,16,20,24,28} of the 32 ports CSI-RS.

In some embodiment, the ports are determined based on a signaling. The signaling indicates a port index. For example, a signaling indicates a port index {0,2,5,7,9,10,23,24},which means these ports are selected.

In some embodiments, the signaling indicates a bitmap. The length of the bitmap is the same as a first number of ports. Each bit in the bitmap corresponds to a port index. For example, ‘0’ means the corresponding port is not selected, ‘1’ means the corresponding port is selected. In some embodiments, the signaling indicates a bitmap. The length of the bitmap is less than a first number of ports. Each bit in the bitmap corresponds to X consecutive port indexes. For example, ‘0’ means the corresponding X ports is not selected, ‘1’ means the corresponding X ports is selected. In some embodiments, the signaling indicates a bitmap. The length of the bitmap is less than a first number of ports. Each bit in the bitmap corresponds to X port indexes. For example, ‘0’ means the corresponding X ports is not selected, ‘1’ means the corresponding X ports is selected.

The mapping parameter indicates a mapping relationship between a gNB antenna and a CSI-RS port.

In some embodiments, port index {0,1,2, . . . 31} corresponds to antenna ports {3000,3001,3002, . . . ,3031}.

In some embodiments, N1, N2 is used to indicate the number of antennas in horizontal and vertical directions. The number of ports of a CSI-RS is equal to N1*N2*2. The N1*N2*2 antennas compose an antenna array. Each port corresponds to one antenna element. The following includes some examples of mapping between the port index and the antenna elements.

Example 1: as shown in FIG. 2, port index mapping starts from the polarization directions in a same position first. After ordering all the polarization directions in a position, the mapping then orders the antenna array for the next two antenna elements which are in the same position in the same column, and so on. After finishing ordering all the elements of the column, the mapping then orders the next column, until all the antenna elements are ordered.

Example 2: FIG. 3 shows port index mapping starts from the polarization direction, first ordering the antenna in a same polarization direction. The antenna in a same polarization direction is ordered from row first and then column. After ordering all the antenna elements in a same polarization direction, the other antenna elements in another polarization direction are ordered.

For another example, port index mapping starts from the polarization direction first, first ordering the antenna in a same polarization direction. The antenna in a same polarization direction is ordered from column first and then row. After ordering all the antenna elements in a same polarization direction, the other antenna elements in another polarization direction are ordered.

Example 3: as shown in FIG. 4, port index mapping starts from the polarization direction in a same position first. After ordering all the polarization directions in the same position, the mapping then orders the antenna for the next two antenna elements which are in the same position in the same row, and so on. After finishing ordering all the elements of the row, the mapping orders the next row, until all the antenna elements are ordered.

In the above examples, the first port index is associated with (or mapped to) the antenna element in the upper row and left column and a first polarization direction. In some embodiments, the first port index can be associated with the antenna element in the upper row and left column and the second polarization direction. In some embodiments, the first port index can be associated with the antenna element in the lowest row and left column and the first polarization direction. In some embodiments, the first port index can be associated with the antenna element in the lowest row and left column and the second polarization direction. In some embodiments, the first port index can be associated with the antenna element in the upper row and right column and a first polarization direction. In some embodiments, the first port index can be associated with the antenna element in the upper row and right column and the second polarization direction. In some embodiments, the first port index can be associated with the antenna element in the lowest row and right column and the first polarization direction. In some embodiments, the first port index can be associated with the antenna element in the lowest row and right column and the second polarization direction. In some embodiments, the first polarization direction is −45° polarization direction, and the second polarization direction is 45° polarization direction. In some embodiments, the first polarization direction is 45° polarization direction, and the second polarization direction is −45° polarization direction.

For example, FIG. 5 shows the first port index is mapped to the antenna element in the lowest row and left column and the first polarization direction. Port index mapping starts from the polarization directions in a same element first. After ordering all the polarization directions in an element, the mapping then orders the antenna for the next element in the same column, and so on. After finishing ordering all the elements of the column, the mapping then orders the next column, until ordering all the antenna.

In some embodiments, the mapping parameter indicates the mapping between port indexes and antenna elements.

In some embodiments, the RRC signaling indicates at least a number of ports list. A combined CSI report configuration is associated with a CSI-RS resource configured with a first number of ports. The combined CSI report configuration indicates a N1, N2. Each of the numbers of ports in the number of ports list should be a value that is equal to an integer multiple of N1 or N2. In some embodiments, a combined CSI report configuration is associated with more than one CSI-RS resource configured with a different number of ports. The combined CSI report configuration indicates a N1, N2 for the largest number of ports. Each of the number of ports of the more than one CSI-RS resource should be a value that is equal to an integer multiple of N1 or N2.

In some embodiments, the RRC signaling indicates at least a number of ports list. A combined CSI report configuration is associated with a CSI-RS resource configured with a first number of ports. The combined CSI report configuration indicates a N1, N2. The available number of ports in the number of ports list includes a value that is equal to an integer multiple of N1 or N2. In some embodiments, a combined CSI report configuration is associated with more than one CSI-RS resource configured with a different number of ports. The combined CSI report configuration indicates a N1, N2. The available number of ports of the more than one CSI-RS resource includes a value that is equal to an integer multiple of N1 or N2.

In some embodiments, the RRC signaling indicates a mapping parameter. The mapping parameter indicates the mapping between port indexes and antenna elements. The mapping parameter is used for a CSI-RS with a first number of ports. If UE needs to select a second number of ports from the first number of ports, UE determines the port index based on a predefined information (or predefined rule). In some embodiments, the predefined information is the port index selected according to the order of port index of antenna elements from row order first and then column order. For example, using mapping example 1, the port index is {0,1,8,9,16,17,24,25,2,3, . . . }. In some embodiments, the predefined information is the port index selected according to the order of port index of antenna element from column order first and then row order. For example, using mapping example 1, the port index is {0,1,2,3,4,5,6,7,8,9, . . . }. In some embodiments, if the second number of ports is the same as N1*2 or N2*2, UE can select port index associated with each row or column, respectively. For example, UE selects 8 ports from 32 ports, using mapping example 1, the port index can be {0,1,2,3,4,5,6,7}, {8,9,10,11,12,13,14,15}, {16,17,18,19,20,21,22,23}, {24,25,26,27,28,29,30,31}, {0,1,8,9,16,17,24,25}, . . . .

In some embodiments, the predefined information is the port indexes selected according to the order of port indexes of antenna elements from row order first and then column order. In each position determined by a row and a column, a first polarization direction is ordered first and then a second polarization direction is ordered. In some embodiments, the predefined information is the port indexes selected according to the order of port indexes of antenna elements from column order first and then row order. In each position determined by a row and a column, a first polarization direction is ordered first and then a second polarization direction is ordered. In some embodiments, the predefined information is the port indexes selected according to the order of port indexes of antenna elements from polarization direction first. For each polarization, column order is ordered first and then row order is ordered. In some embodiments, the predefined information is the port indexes selected according to the order of port indexes of antenna elements from polarization direction first. For each polarization, row order is ordered first and then column order is ordered.

In some embodiments, if the second number of ports is the same as A*N1*2 or A*N2*2, UE can select port index associated with each A rows or A columns, respectively. A is an integer less than 9.

In some embodiments, UE is configured with a combined CSI report configuration and a number of ports list. The combined CSI report configuration is associated with one CSI-RS resource. The CSI-RS resource is associated with one power offset and one number of ports. The number of ports list indicates what kind of CSI needs to be reported. If the number of ports in the number of ports list is the same as the number of ports associated with the CSI-RS resource, UE reports CSI report of the number of ports based on the CSI-RS resource. If the number of ports in the number of ports list is not the same as the number of ports associated with the CSI-RS resource, UE needs to select corresponding number of ports from the ports associated with the CSI-RS resource. The selecting procedure is according to a predefined information (or predefined rules) or a signaling. UE uses the CSI-RS transmitted in the selected ports to report CSI report of the number of ports.

In some embodiments, UE is configured with a combined CSI report configuration and a number of ports list. The combined CSI report configuration is associated with one CSI-RS resource. The CSI-RS resource is associated with one power offset (P) and a first number of ports. The number of ports list indicates what kind of CSI needs to be reported. If a number of ports in the number of ports list is the same as the first number of ports associated with the CSI-RS resource, UE reports CSI report of the number of ports based on the CSI-RS resource. If a second number of ports in the number of ports list is not the same as the first number of ports associated with the CSI-RS resource, UE needs to select corresponding second number of ports from the ports associated with the CSI-RS resource. The selecting procedure is according to a predefined information (or predefined rules) or a signaling. UE uses the CSI-RS transmitted in the selected ports and an assumed power offset to report CSI report of the second number of ports. The assumed power offset (P2) may be determined by the second number of ports (T2), the first number of ports (T1), and the power offset (P). For example, P2=P-10*log10 (T2/T1).

In some embodiments, UE is configured with a combined CSI report configuration and a number of ports list and a power offset list. Each number of ports in the number of ports list is associated with a power offset in the power offset list. The combined CSI report configuration is associated with one CSI-RS resource. The CSI-RS resource is associated with one power offset and one number of ports. The number of ports list indicates what kind of CSI needs to be reported. If the number of ports in the number of ports list is the same as the number of ports associated with the CSI-RS resource, UE reports CSI report of the number of ports based on the CSI-RS resource. If the number of ports in the number of ports list is not the same as the number of ports associated with the CSI-RS resource, UE needs to select corresponding number of ports from the ports associated with the CSI-RS resource. The selecting procedure is according to a predefined information (or predefined rules) or a signaling. UE uses the CSI-RS transmitted in the selected ports and the corresponding power offset to report CSI report of the number of ports.

In some embodiments, UE is configured with a combined CSI report configuration and a TCI state list. The combined CSI report configuration is associated with one CSI-RS resource. The CSI-RS resource is associated with one power offset and one number of ports and/or a TCI state. The TCI state list indicates what kind of CSI needs to be reported. For each TCI state in the TCI state list, UE needs to use the CSI-RS and the TCI state to report CSI of the TCI state.

In some embodiments, UE is configured with a combined CSI report configuration and a TCI state ID list. The combined CSI report configuration is associated with one CSI-RS resource. The CSI-RS resource is associated with one power offset and one number of ports and/or a TCI state. The TCI state ID list indicates what kind of CSI needs to be reported. For each TCI state ID in the TCI state ID list, it will associate with a TCI state. UE needs to use the CSI-RS and the TCI state to report CSI (e.g., L1-RSRP, CRI, or L1-SINR) of the TCI state ID.

In some embodiments, UE is configured with a combined CSI report configuration. The combined CSI report configuration is associated with one CSI-RS resource. The CSI-RS resource is associated with one power offset and a first number of ports. UE needs to report CSI for each valid number of ports that is less than or equal to the first number of ports. If a number of ports is not the same as the first number of ports associated with the CSI-RS resource, UE needs to select corresponding number of ports from the ports associated with the CSI-RS resource. The selecting procedure is according to a predefined information (or predefined rules) or a signaling. UE uses the CSI-RS transmitted in the selected ports to report CSI report of a number of ports.

Valid number of ports includes {1,2,4,8,12,16,24,32}.

For each number of ports that is not equal to the first number of ports, UE needs to select corresponding number of ports from the ports of CSI-RS resource. UE uses the CSI-RS transmitted in the selected ports to report CSI report of a number of ports.

### III. Embodiment 2

UE generates CSI report based on the measurement on CSI-RS. To make UE report multiple CSI for different numbers of ports or different power offsets or different resource categories in one CSI reporting, different CSI-RSs configured with different numbers of ports, different power offsets, or different resource categories should be associated with one CSI-ReportConfig. In this section, the methods to associate one CSI-ReportConfig with multiple CSI-RS resources configured with different numbers of ports, different power offsets, different TCI states, different TCI state IDs, or different resource categories are provided.

2. The high layer signaling includes at least one of the following: multiple CSI report indication, a number of reports in one combined CSI reporting, a maximum number of a reports in one combined CSI reporting, a number of ports list, a power offsets list, a TCI state list, a TCI state ID list, a group ID list, or a resource type (also corresponding to resource categories) list.

2.1. In some embodiments, a high layer signaling includes a multiple CSI report indication. The multiple CSI report indication (also corresponding to an indication to enable the combined CSI report) is used to indicate whether or not enable multiple CSI reported in one CSI reporting.

2.1.1. In some embodiments, the multiple CSI is reported for different number of ports. In some embodiments, the multiple CSI is reported for at least two number of ports. In some embodiments, the multiple CSI is reported for different power offsets. In some embodiments, the multiple CSI is reported for different resource type. In another word, the CSI for each number of port/or power offset/or resource type associated with a same CSI report configuration will be included in a combined CSI report.

2.1.2. The multiple CSI report indication is configured or indicated ‘enable’, which indicates (effects) at least one of the following:

2.1.2.1. Reporting multiple CSI in one CSI reporting is enabled;

2.1.2.2. Reporting multiple CSI for different number of ports in one CSI reporting is enabled;

2.1.2.3. Reporting multiple CSI for different power offsets or different resource types in one CSI reporting is enabled; or

2.1.2.4. multiple CSI configuration is enabled.

2.1.2.4.1. Details of multiple CSI configuration is in embodiment 3.

2.1.3. In some embodiments, the multiple CSI report indication is a new CSI report quantity.

2.1.3.1. CSI report quantity is configured in a CSI-ReportConfig and can be set to at least one of ‘none’, ‘cri-RI-PMI-CQI’, ‘cri-RI-i1’, ‘cri-RI-CQI’, ‘cri-RSRP’, ‘ssb-Index-RSRP’, or ‘cri-RI-LI-PMI-CQI’.

2.1.3.2. The new CSI report quantity indicates multiple CSI reported in one CSI reporting is used, and in the CSI reporting, which kind of CSI should be reported.

2.1.3.2.1. For example, the new CSI report quantity is ‘cri-RI-i1-multi’, then in one CSI reporting, multiple CSI is reported, and CRI, RI, I1, should be included in each of the multiple CSI reports.

2.1.3.2.2. For another example, the new CSI report quantity is ‘cri-RI-PMI-CQI-multi’, then in one CSI reporting, multiple CSI are reported, and CRI, RI, PMI, CQI should be included in each of the multiple CSI reports. For another example, the new CSI report quantity is ‘cri-RSRP-multi’, then in one CSI reporting, multiple CSI are reported, and CRI and L1-RSRP should be included in each of the multiple CSI reports.

As discussed above, to make UE report multiple CSI in one reporting, a specific configuration is needed, the specific configuration is corresponding to multiple CSI configuration.

2.2. In some embodiments, a high layer signaling includes at least a number of reports in one CSI reporting (also corresponding to the combined CSI report).

2.2.1. In some embodiments, if a number of reports in one CSI reporting is configured or configured to a value greater than one, reporting multiple CSI in one CSI reporting is enabled. In another words, if a number of reports in one CSI reporting is configured or configured to a value greater than one, the effect is same as a multiple CSI report indication is configured or indicated ‘enable’.

2.2.2. In some embodiments, a number of reports in one CSI reporting can be configured if a multiple CSI report indication is configured or indicated ‘enable’.

2.2.3. In some embodiments, the number of reports in one CSI reporting also indicates at least one of the following: the number of different resource types which associated with a CSI report configuration, the number of reports which can be reported in one CSI reporting, the number of resource types associated with a CSI report configuration, the number of codebook configuration associated with a CSI report configuration, the number of codebook subset restriction associated with a CSI report configuration, the number of RI restriction associated with a CSI report configuration, number of CSI resource configuration associated with one CSI report configuration, number of CSI-RS resource set configuration associated with a CSI resource configuration, number of Resource mapping signaling associated with a CSI-RS resource, number of resource groups associated with a CSI-RS resource set, number of resource groups associated with a CSI report configuration.

2.3. In some embodiments, a high layer signaling includes at least a maximum number of reports in one CSI reporting. The maximum number of reports in one CSI reporting indicates at least one of the following: the maximum number of resource types which associated with a CSI report configuration, the maximum number of different numbers of resource types which associated with a CSI report configuration, the maximum number of reports which can be reported in one CSI reporting.

2.3.1. In some embodiments, if a maximum number of reports in one CSI reporting is configured or configured to a value greater than one, reporting multiple CSI in one CSI reporting is enabled. In another words, if a maximum number of reports in one CSI reporting indication is configured or configured to a value greater than one, the effect is same as a multiple CSI report indication is configured or indicated ‘enable’.

2.3.2. In some embodiments, a maximum number of reports in one CSI reporting indication can be configured if a multiple CSI report indication is configured or indicated ‘enable’.

2.3.3. In some embodiments, the maximum number of the CSI reported in one CSI reporting is V. In some embodiments, V is an integer greater than 2 and less than or equal to 8.For example, V=4.

2.3.4. In some embodiments, the maximum number of reports in one CSI reporting indicates at least one of the following:

2.3.4.1. the maximum number of CSI resource configuration associated with one CSI report configuration.

2.3.4.2. the maximum number of resource type associated with one CSI report configuration.

2.3.4.3. the maximum number of CSI-RS resource set configuration associated with a CSI resource configuration.

2.3.4.4. the maximum number of Resource mapping signaling associated with a CSI-RS resource.

2.3.4.5. the maximum number of CSI-RS resource set groups associated with a CSI report configuration.

2.3.4.6. the maximum number of codebook subset restriction or maximum number of RI restriction associated with one CSI report configuration.

2.3.4.7. the maximum number of different number of ports, different power offsets, or different TCI-states associated with one CSI report configuration.

2.3.4.8. the maximum number of codebook configuration associated with one CSI report configuration.

2.3.4.9. the maximum number of CSI-RS resource configured with different number of ports or resource types or power offsets and associated with one CSI report configuration.

2.4. In some embodiments, the high layer signaling includes at least a list. The list is one of the following: a number of ports list, a power offset list, a resource type list, a TCI state list, a TCI state ID list, or a group ID list. The number of ports list includes more than one number of port. The power offset list includes more than one power offsets. The resource type list includes more than one resource type or index. The group ID list includes more than one group ID.

2.4.1. In some embodiments, the number of the entries in the list indicates the number of CSI reports in one reporting.

2.4.2. In some embodiments, the list indicates a resource each of the multiple CSI reports for.

2.4.3. In some embodiments, the order of the list is the order of CSI reports in a multiple CSI reports.

2.4.4. In some embodiments, the order or the index of the list is used to combine at least one of “codebook configuration, codebook subset restriction, RI restriction” and a resource type.

2.4.5. In some embodiments, the list indicates a resource type for each of the multiple CSI reports.

2.4.6. In some embodiments, each entry in the list is associated with a resource type.

2.4.7. In some embodiments, each entry in the list is associated with at least one of “codebook configurations, codebook subset restrictions, or RI restrictions.”

2.4.8. In some embodiments, each entry in the list is associated with at least one of “a TCI state ID or a TCI state.”

2.4.9. In some embodiments, the TCI state list includes more than one TCI state, each TCI state being associated with one or more CSI-RS resources.

2.4.10. In some embodiments, the TCI state ID list includes more than one TCI state ID, each TCI state ID being associated with one or more CSI-RS resources.

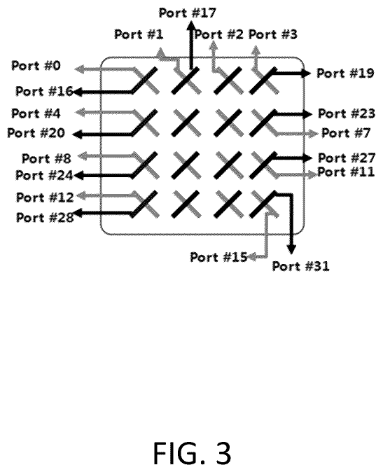

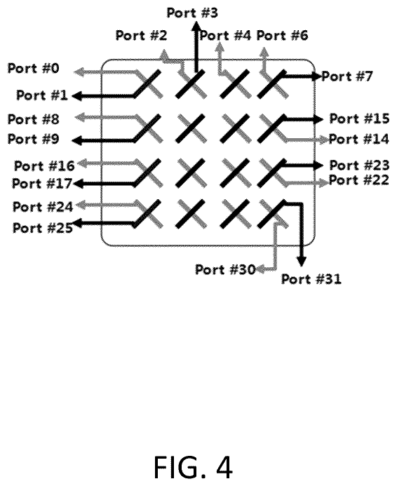

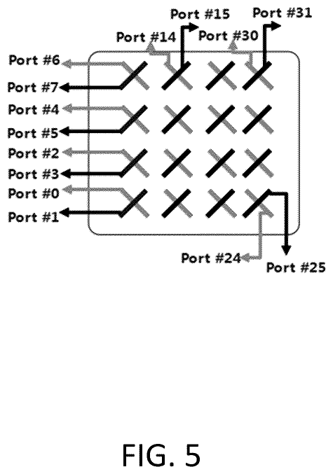

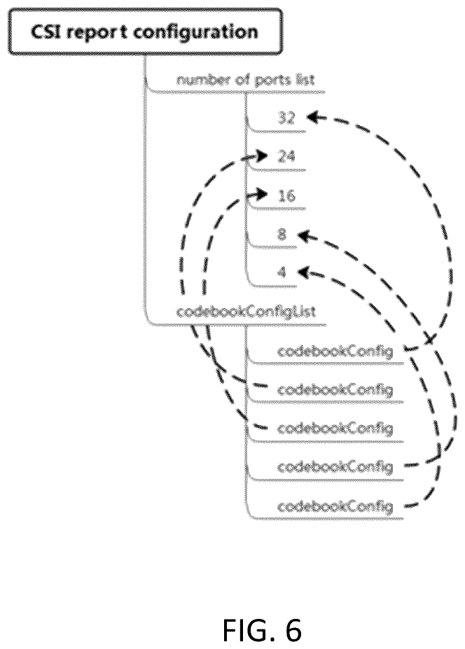

For example, as shown in FIG. 6, a number of ports list are configured in a CSI report configuration (CSI-ReportConfig), and multiple codebookConfig are also configured. Then each codebookConfig is used for one number of port in the number of ports list in order.

2.5. In some embodiments, at least one of the multiple CSI report indication, a number of reports in one CSI reporting, a maximum number of a reports in one CSI reporting, and a list is/are configured in a CSI report configuration.

### IV. Embodiment 3

As mentioned above, one report is for one resource type, and each report is according to different CSI-RS resources. Multiple reports are in one CSI reporting. How to combine the CSI-RS resources and the CSI report configurations is described in this section.

3. To enable the multiple CSI reports reported in one reporting, multiple CSI configuration is needed.

Multiple CSI configuration includes at least one of the following:

3.1. A CSI resource configuration associate with more than one CSI-RS resource set

3.1.1. Different CSI-RS resource set associates with at least one of the following: different resource types, different power offsets, different number of ports, different TCI states, different TCI state IDs, or different groups. In some embodiments, CSI-RS resource set configuration corresponds to NZP-CSI-RS-ResourceSet.

3.1.2. Different CSI-RS resource set also corresponds to CSI-RS resource with

different resource types.

3.1.3. Each CSI-RS resource set may associate with at least one of the following: a codebookConfig, a RI (rank indicator) restriction, a codebook subset restriction.

3.1.4. In some embodiments, the number of ports configured in one CSI-RS resource set is same, the number of ports for different CSI-RS resource can be different. In some embodiments, the TCI state associated with the CSI-RS resources in one CSI-RS resource set is the same. The TCI state associated with the CSI-RS resources for different CSI-RS resources can be different.

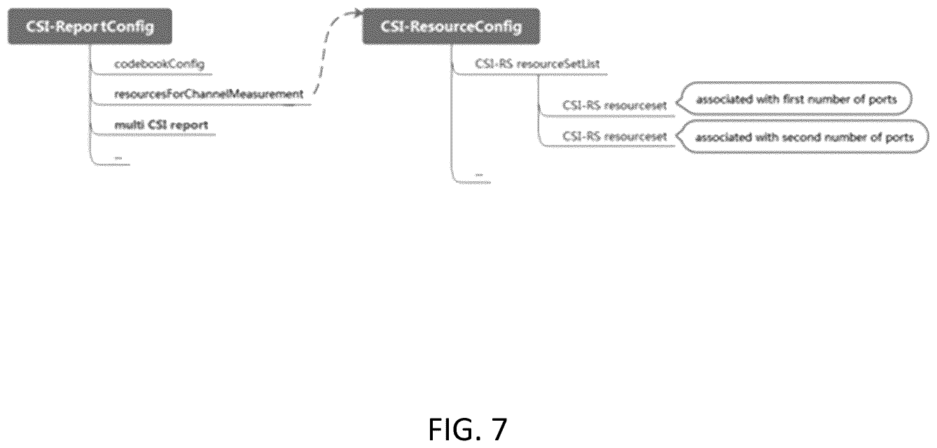

3.1.5. One example is shown below in FIG. 7.

In some embodiments, the more than one CSI-RS resource set is divided into different groups and associated with a group ID/index. CSI-RS resource set in different groups is equal to CSI-RS resource with different resource types. Each group may associate with at least one of the following: a codebookConfig, a RI (rank indicator) restriction, or a codebook subset restriction.

3.2. A CSI-RS resource set configuration contains more than one CSI resource configured with different resource types;

3.2.1. Each CSI resource configured with different resource types may associate with at least one of the following: a codebookConfig, a RI (rank indicator) restriction, or a codebook subset restriction. In some embodiments, the qcl-InfoPeriodicCSI-RS in different CSI-RS (or CSI) resources is configured with different values.

In some embodiments, a CSI-RS resource set configuration contains more than one CSI resource. The more than one CSI resource is divided into more than two groups. Each group may associate with at least one of the following: a codebookConfig, a RI (rank indicator) restriction, or a codebook subset restriction. Different groups correspond to different resource types. In some embodiments, a CSI-RS resource set configuration contains more than one CSI resource. The more than one CSI resource is divided into two groups. Each group may be associated with at least one of the following: a codebookConfig, a RI (rank indicator) restriction, or a codebook subset restriction. Different groups correspond to different TCI states or TCI state IDs. In some embodiments, the qcl-InfoPeriodicCSI-RS in different groups is configured with different values.

3.3. A CSI-RS resource (NZP-CSI-RS-Resource) includes more than one Resource Mapping (ResourceMapping) signaling.

3.3.1. Different resource Mapping signaling includes at least one of the following: different number of ports, different group index/ID.

3.3.2. Each resource mapping signaling may associate with at least one of the following: a codebookConfig, a RI (rank indicator) restriction, a codebook subset restriction.

3.3.3. Each resource mapping is equal to a resource configured with a resource type.

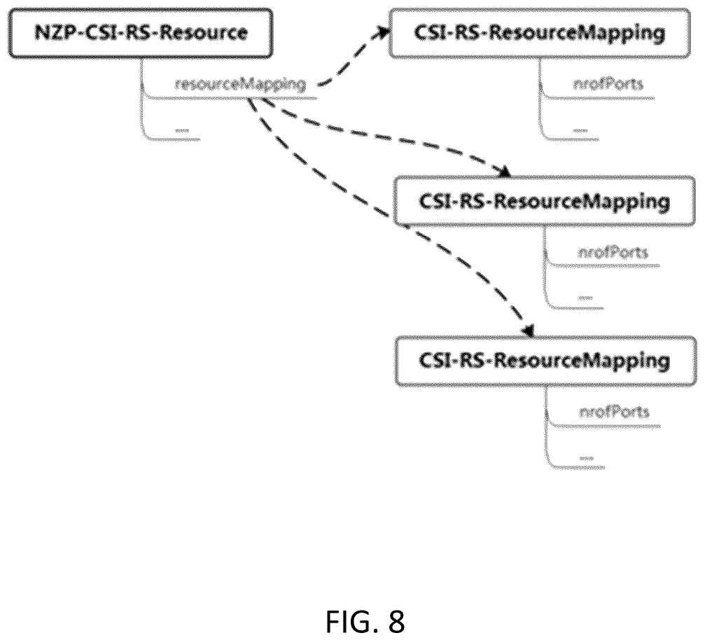

For example, as shown in FIG. 8, one NZP-CSI-RS-Resource associates with three resource mapping signaling. In some embodiments, the nrofPorts in different resource mapping signalings are different. In some embodiments, the different resource mappings include at least one of the following: different frequencyDomainAllocation, different cdm-type, different density, or same nrofPorts.

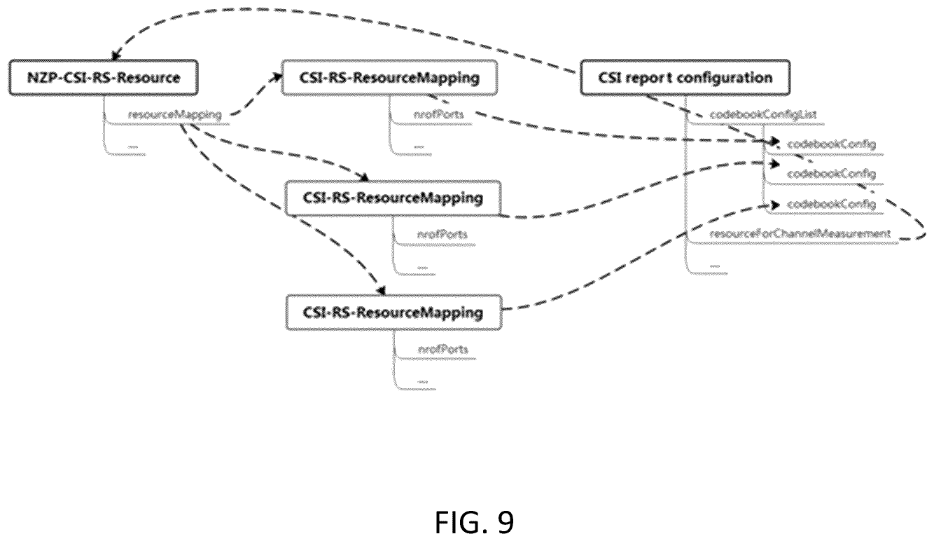

For example, as shown in FIG. 9, each resource mapping associate with one codebookConfig. In some embodiments, the nrofPorts in different resource mapping signalings are different.

3.4. A CSI report configuration associates with more than one CSI resource configurations;

3.5. A CSI report configuration can associate with more than one CSI resource configuration for channel measurement.

3.5.1. Different CSI resource configurations associates with at least one of the following: different resource type, different power offset, different number of ports, different group.

3.5.2. Each CSI resource configuration corresponds to a CSI resource configured with a resource type.

3.5.3. Each CSI resource configuration may associate with at least one of the following: a codebookConfig, a RI (rank indicator) restriction, a codebook subset restriction.

3.5.4. In some embodiments, the CSI resource configurations associate with the same CSI report configuration are associated with a same BWP (ID).

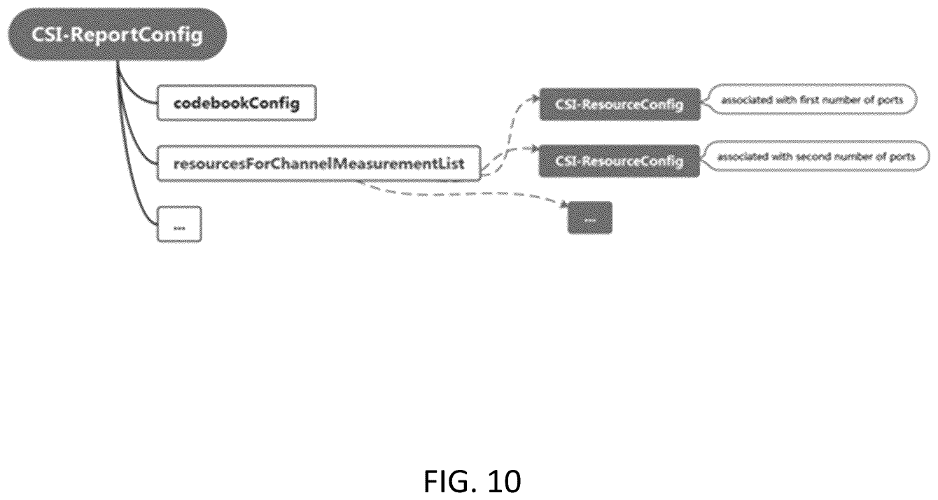

3.5.5. One example as shown in FIG. 10 below, a resourcesForChannelMeasurementList (also can be resourcesForChannelMeasurement) in a CSI-reportConfig associate with multiple CSI-ResourceConfig, and different CSI-ResourceConfig include CSI-RS resource associated with different number of ports.

3.6. A CSI report configuration includes more than one codebook configuration.

3.6.1. In some embodiments, each codebook configuration is associated with a resource type.

3.6.2. In some embodiments, each codebook configuration is used for one CSI report among the multiple CSI reports.

3.7. A CSI report configuration includes a codebook configuration which includes more than one codebook subset restriction or more than one RI restriction.

3.7.1. In some embodiments, each codebook subset restriction or RI restriction is associated with a resource type.

3.7.2. In some embodiments, each codebook subset restriction or RI restriction is used for one CSI report among the multiple CSI reports.

In some embodiments, a combined CSI report configuration is associated with a plurality of differing CSI-RS resources.

In some embodiments, a plurality of differing CSI-RS resources include one CSI-RS resource. In some embodiments, a combined CSI report including a group of CSI reports is obtained according to one CSI-RS resource. For example, each of the CSI report in the combined CSI report is based on a same CSI-RS resource and an assumption of number of ports. For another example, each of the CSI report in the combined CSI report is based on a same CSI-RS resource and an assumption of power offset. The assumption of number of ports or the assumption of power offset is configured by a RRC signaling, e.g., a number of ports list or a power offset list.

In some embodiments, each differing CSI-RS resource or CSI-RS resource configured with a different resource type can be a CSI-RS resource setting, a CSI-RS resource set, a CSI-RS resource group, a group of CSI-RS resource set, or a resource mapping.

In some embodiments, the combined CSI report configuration includes a codebook configuration, and the codebook configuration includes at least one of the following: one or more bitmaps for a codebook subset restriction, one or more bitmaps for a rank indicator (RI) restriction, a codebook subset restriction, or a RI restriction.

In some embodiments, the length of the bitmap used for codebook subset restriction is the same as the length of the codebook subset restriction, or the length of bitmap used for RI restriction is the same as the length of the codebook subset restriction.

In some embodiments, the length of the bitmap used for codebook subset restriction is less than the length of the codebook subset restriction, or the length of bitmap used for RI restriction is less than the length of the codebook subset restriction.

In some embodiments, the length of the bitmap used for codebook subset restriction (A) is obtained by dividing the length of the codebook subset restriction (B) by an integer (C), or the length of bitmap used for RI restriction (A1) is obtained by dividing the length of the RI restriction (B1) by an integer (C1).

In some embodiments, C or C1 is equal to dividing the number of ports associated with the first CSI report by the number of ports associated with the other CSI report.

In some embodiments, a codebookConfig includes at least a codebook subset restriction and one or more bitmap for a codebook subset restriction. The codebook subset restriction is for a first CSI report in the combined CSI report. The codebook subset restriction for the other CSI report in the same combined CSI report is obtained by a bitmap and the codebook subset restriction for the first CSI report. For example, each bit in the bitmap indicates whether the corresponding bit in the codebook subset restriction is used to compose the codebook subset restriction of other CSI reports. For another example, each bit in the bitmap is associated with a group of bits in the codebook subset restriction. Each bit in the bitmap indicates whether or not the corresponding bits in the codebook subset restriction are used to compose the codebook subset restriction of other CSI reports.

In some embodiments, a codebookConfig includes at least a RI restriction and one or more bitmap for a RI restriction. The RI restriction is for a first CSI report in the combined CSI report. The RI restriction for the other CSI report in the same combined CSI report is obtained by a bitmap and the RI restriction for the first CSI report. For example, each bit in the bitmap indicates whether the corresponding bit in the RI restriction is used to compose the RI restriction of other CSI reports. For another example, each bit in the bitmap is associated with a group of bits in the RI restriction. Each bit in the bitmap indicates whether or not the corresponding bits in the RI restriction are used to compose the RI restriction of other CSI reports.

In some embodiments, the first CSI report is the CSI report associated with a maximum number of ports or maximum power offset or minimum power offset.

In some embodiments, the plurality of differing CSI-RS resources associated with the combined CSI report configuration are to be restricted within a same slot. In other words, the CSI-RSs are transmitted/received in one slot. In some embodiments, the plurality of differing CSI-RS resources associated with the combined CSI report configuration are to be restricted within 1 ms. In some embodiments, the plurality of differing CSI-RS resources associated with the combined CSI report configuration are to be restricted within a X continuous slots without DL/UL switch among the slots, where the X is an integer greater than or equal to 0 and less than 20. In some embodiments, the plurality of differing CSI-RS resources associated with the combined CSI report configuration are to be restricted within a X continuous slots, where the X is an integer greater than or equal to 0 and less than 20.

In some embodiments, the plurality of differing CSI-RS resources associated with the combined CSI report configuration are configured within a same DRX active time. In other words, the CSI-RSs are transmitted/received within a same DRX active time.

In some embodiments, a combined CSI report includes a group of CSI reports. In some embodiments, a combined CSI report includes at least one of the following: a plurality of RIs, a plurality of CRIs, a plurality of PMIs, a plurality of CQIs, a plurality of L1-RSRP, a plurality of L1-SINR, a plurality of differential L1-RSRP, or a plurality of differential L1-SINR. In some embodiments, each CSI report of the group of CSI reports includes at least one of the following: a RI, a CRI, a PMI, a CQI, a L1-RSRP, a L1-SINR, a differential L1-RSRP, or a differential L1-SINR. The differential L1-RSRP value is computed with 2 dB step size with a reference to the largest measured L1-RSRP value that is part of the same combined CSI report. In some embodiments, L1-RSRP includes L1-RSRP and differential L1-RSRP. The differential L1-SINR is computed with 1 dB step size with a reference to the largest measured L1-SINR value that is part of the same combined CSI report. In some embodiments, L1-SINR includes L1-SINR and differential L1-SINR. In some embodiments, in a combined CSI report, UE reports a largest measured L1-RSRP value and multiple differential L1-RSRP values based on the associated CSI-RS resources. In some embodiments, in a combined CSI report, UE reports a largest measured L1-SINR value and multiple differential L1-SINR values based on the associated CSI-RS resources. In some embodiments, in a combined CSI report, UE reports multiple measured L1-RSRP values. In some embodiments, in a combined CSI report, UE reports multiple measured L1-SINR values.

In some embodiments, in a combined CSI report, UE reports X L1-RSRP values for each kind of resource type (e.g., TCI state, or TCI state ID). in some embodiments, X value is configured by a RRC signaling. In some embodiments, X is indicated by a DCI. In some embodiments, X is indicated by a MAC CE. X is an integer greater than or equal to 0 and less than 9. In some embodiments, in a combined CSI report, UE reports different numbers of L1-RSRP values for different kinds of resource types (e.g., TCI state, or TCI state ID). In some embodiments, in a combined CSI report, UE reports different numbers of L1-RSRP values for different resource types (e.g., number of ports, power offset).

In some embodiments, a combined CSI report configuration is associated with a CSI resource configuration. The CSI resource configuration includes CSI resources configured with different power offsets or different numbers of ports. UE calculates CSI (e.g., RI, CQI, PMI) based on the CSI resources configured with different power offsets or different numbers of ports. UE reports a CSI report (e.g., RI, CQI, or PMI) which is associated with a specific resource and a resource indication.

In some embodiments, a combined CSI report configuration is associated with one or more CSI resource configurations. The one or more CSI resource configurations include multiple CSI resources configured with different numbers of ports, different TCI states (or different TCI state IDs). CSI resources configured with the same number of ports are associated with one or more TCI states (or TCI states ID), respectively. UE reports multiple CSI (e.g., L1-RSRP, or L1-SINR) for each number of ports. For example, a combined CSI report configuration is associated with one CSI resource configuration. The CSI resource configuration includes Y CSI resources configured with U number of ports, V TCI states. Y CSI resources are divided into U groups, The CSI resources in the same group are associated with the same number of ports and TCI states. The CSI resources in the same group are associated with the same or different TCI states. The TCI states associated with the CSI resources in the same group include V TCI states. UE reports V CSI (e.g., L1-RSRP, or L1-SINR) for each group. Hence, UE reports V*U CSI in the combined CSI report.

In some embodiments, a combined CSI report configuration is associated with one or more CSI resource configurations. The one or more CSI resource configurations include multiple CSI resources configured with different power offsets, different TCI states (or different TCI state IDs). CSI resources configured with the same power offset are associated with one or more TCI states (or TCI states IDs), respectively. UE reports multiple CSI (e.g., L1-RSRP, or L1-SINR) for each power offset. For example, a combined CSI report configuration is associated with one CSI resource configuration. The CSI resource configuration includes Y CSI resources configured with U power offsets, V TCI states. Y CSI resources are divided into U groups. The CSI resources in the same group are associated with the same power offset and TCI state. The CSI resources in the same group are associated with the same or different TCI states. The TCI states associated with the CSI resources in the same group include V TCI states. UE reports V CSI (e.g., L1-RSRP, or L1-SINR) for each group. Hence, UE reports V*U CSI in the combined CSI report.

In some embodiments, a combined CSI report configuration is associated with one or more CSI resource configurations. The one or more CSI resource configurations include multiple CSI resources configured with different power offsets, different numbers of ports, different TCI states (or different TCI state IDs). CSI resources configured with the same power offset and the same number of ports are associated with one or more TCI states (or TCI state IDs), respectively. UE reports multiple CSI (e.g., L1-RSRP, or L1-SINR) for each power offset and number of ports. For example, a combined CSI report configuration is associated with one CSI resource configuration. The CSI resource configuration includes Y CSI resources configured with U power offsets, U number of ports, V TCI states. Y CSI resources are divided into U groups. The CSI resources in the same group are associated with the same power offset, the same number of ports and TCI state. The CSI resources in the same group are associated with the same or different TCI states. The TCI states associated with the CSI resources in the same group includes V TCI states. UE reports V CSI (e.g., L1-RSRP, or L1-SINR) for each group. Hence, UE reports V*U CSI in the combined CSI report.

The specific resource is at least one of the following:

A CSI resource which is associated with a largest RI, a largest CQI, or a largest RSRP.

The resource indication indicates at least one of the following: which CSI resources the CSI report is associated with, a port indication, a number of ports, a power offset, a delta of numbers of ports, a delta of power offsets.

In some embodiments, the resource indication indicates which CSI resources the CSI report is associated with. In other words, the resource indication indicates the specific resources. The resource indication indicating which CSI resources the CSI report is associated with may correspond to an indication that indicates a CRI, a resource index, or a group ID/index.

In some embodiments, the resource indication indicates a port indication. The port indication indicates which ports are used to generate the CSI report.

In some embodiments, the resource indication indicates a number of ports. The number of ports indicates which number of ports is used (or assumed) to generate the CSI report.

In some embodiments, the resource indication indicates a power offset. The power offset indicates which power offset is used (or assumed) to generate the CSI report.

In some embodiments, the resource indication indicates a delta of numbers of ports. The delta of numbers of ports indicates an offset over a first number of ports. A number of ports can be obtained by dividing the first number of ports by the delta of numbers of ports, and indicates which number of ports is used (or assumed) to generate the CSI report. In another example, a number of ports can be obtained by subtracting the delta of numbers of ports from the first number of ports.

In some embodiments, the resource indication indicates a delta of power offsets. The delta of power offsets indicates an offset over a first power offset. A power offset can be obtained by dividing the first power offset by the delta of power offsets, and indicates which power offset is used (or assumed) to generate the CSI report. In another example, a power offset can be obtained by subtracting the delta of power offsets from the first power offset. In another example, a power offset can be obtained by adding the delta of power offsets and the first power offset.

In some embodiments, the first power offset is the maximum or minimum power offset in the CSI resource configuration. In some embodiments, the first number of ports is the maximum number of ports in the CSI resource configuration.

In some embodiments, the combined CSI report includes a group of CSI reports. The CSI resources associated with one CSI report of the group of CSI reports are configured with one power offset value or one number of ports value.

In some embodiments, the combined CSI report configuration is associated with a CSI resource configuration. The CSI resource configuration includes one or more CSI resources. The CSI resources have a same number of ports or a same power offset. In some embodiments, the first power offset is the configured power offset in the CSI resource configuration. In some embodiments, the first number of ports is the configured number of ports in the CSI resource configuration. In some embodiments, UE is also configured with a number of ports list or a power offset list. UE uses the CSI resources to generate CSI report of each number of ports in the number of ports list, or UE uses the CSI resources to generate CSI report of each number of ports in the power offset list. For example, the combined CSI report configuration is associated with a CSI resource configuration. The CSI resource configuration includes one or more CSI resources. The CSI resources have a same number of ports (e.g., 32). UE is also configured with a number of ports list (e.g., {32,16}). UE reports CSI of 32 ports according to the CSI resources. UE selects 16 ports from the 32 ports CSI resource, and reports CSI of 16 ports according to the CSI-RS transmitted in the selected 16 ports. For another example, the combined CSI report configuration is associated with a CSI resource configuration. The CSI resource configuration includes one or more CSI resources. The CSI resources have a same power offset (e.g., 2 dB). UE is also configured with a number of ports list (e.g., {2 dB,4 dB}). UE reports CSI of 2 dB according to the CSI resources. UE changes the power offset value that is configured in the CSI resource to 4 dB, and reports CSI of 4 dB according to the CSI resource. In some embodiments, CSI resource corresponds to CSI-RS resource.

### V. Embodiment 4

4. In some embodiments, the time and frequency of a first resource with a first resource type is a subset of the time and frequency of a second resource with a second resource type. The first resource and second resource are associate with a same CSI report configuration.

4.1. In some embodiments, the time and frequency of a first resource with a first number of ports is a subset of the time and frequency of a second resource with a second number of ports. The first resource and second resource are associate with a same CSI report configuration. The first number of ports is less than or equal to the second number of ports.

4.2. In some embodiments, the time and frequency of a first resource with a first power offset is a subset of the time and frequency of a second resource with a second power offset. The first resource and second resource are associate with a same CSI report configuration. The first power offset is less than or equal to the second power offset.

In some embodiments, if the time and frequency of a first resource is a subset of the time and frequency of a second resource, and the first resource and the second resource are associated with a same CSI report configuration, gNB only transmits the CSI-RS based one the second resource. In some embodiments, if the time and frequency of a first resource is a subset of the time and frequency of a second resource, and the first resource and the second resource are associated with a same CSI report configuration, gNB transmits each CSI-RS based on each of the resource.

In some embodiments, a combined CSI report configuration is associated with one or more CSI resource configurations. A first CSI resource configuration of the one or more CSI resource configurations includes a first one or more CSI reference signal (CSI-RS) resources, where a second CSI resource configuration of the one or more CSI resource configurations includes a second one or more CSI-RS resources, and where the first one or more CSI-RS resources is a subset of the second one or more CSI-RS resources.

In some embodiments, the first CSI resource configuration is the same as the second CSI resource configuration. In another word, the first CSI resource configuration is the second CSI resource configuration. In some embodiments, if a combined CSI report configuration is associated with one CSI resource configuration, the first CSI resource configuration is the second CSI resource configuration.

In some embodiments, the first one or more CSI-RS resources is a subset of the second one or more CSI-RS resources. At least the time and frequency of a first one or more CSI-RS resources is a subset of the time and frequency of a second one or more CSI-RS resources.

In some embodiments, the first one or more CSI-RS resources is a subset of the second one or more CSI-RS resources. At least the time or frequency of the first one or more CSI-RS resources is a subset of the time or frequency of the second one or more CSI-RS resources.

In some embodiments, the first one or more CSI-RS resources is a subset of the second one or more CSI-RS resources. At least the N1 associated with the first one or more CSI-RS resources is less than the N1 associated with the second one or more CSI-RS resources.

In some embodiments, the first one or more CSI-RS resources is a subset of the second one or more CSI-RS resources. At least the N2 associated with the first one or more CSI-RS resources is less than the N2 associated with the second one or more CSI-RS resources.

In some embodiments, the first one or more CSI-RS resources is a subset of the second one or more CSI-RS resources. At least the number of ports associated with the first one or more CSI-RS resources is less than the number of ports associated with the second one or more CSI-RS resources.

In some embodiments, the first one or more CSI-RS resources is a subset of the second one or more CSI-RS resources. At least the power offset associated with the first one or more CSI-RS resources is less than the power offset associated with the second one or more CSI-RS resources.

In some embodiments, the first one or more CSI-RS resources is a subset of the second one or more CSI-RS resources. At least the number of CDM groups associated with the first one or more CSI-RS resources is less than or equal to the number of CDM (code division multiplexing) groups associated with the second one or more CSI-RS resources.

In some embodiments, the first one or more CSI-RS resources is a subset of the second one or more CSI-RS resources. At least the powerControlOffset value associated with the first one or more CSI-RS resources is less than or equal to the number of powerControlOffset value associated with the second one or more CSI-RS resources.

In some embodiments, the first one or more CSI-RS resources is a subset of the second one or more CSI-RS resources. At least the powerControlOffsetSS value associated with the first one or more CSI-RS resources is less than or equal to the number of powerControlOffsetSS value associated with the second one or more CSI-RS resources.

### VI. Embodiment 5

5. In some embodiments, the combination of codebook subset restriction, or RI restriction, or codebook configuration and resource type is according to csi-ResourceConfigId, or a csi-ResourceConfig Index, or an index, or a group number, or an order.

For example, the first codebook subset restriction or first RI restriction or first codebook configuration to last codebook subset restriction or last RI restriction or last codebook configuration correspond to the CSI-RS resource configured with the smallest number of ports to the CSI-RS resource configured with the largest number of ports, respectively.

For example, the first codebook subset restriction or first RI restriction or first codebook configuration to last codebook subset restriction or last RI restriction or last codebook configuration correspond to the CSI-RS resource configured with the lowest group ID or lowest index to the CSI-RS resource configured with the largest group ID or largest index, respectively.

For example, the first codebook subset restriction or first RI restriction or first codebook configuration to last codebook subset restriction or last RI restriction or last codebook configuration correspond to the CSI-RS resource configured with the smallest power offset to the CSI-RS resource configured with the largest power offset, respectively.

### VII. Embodiment 6

### Multiple CSI Report

6. If a first condition is satisfied, UE can report multiple CSI in one CSI reporting. The multiple CSI report is generated based on measurement on the CSI resource which is associated with the CSI report configuration. In some embodiments, each of CSI report in the multiple CSI reports is associate with a resource type.

6.1. CSI Resource

6.1.1. In some embodiments, each CSI report of the multiple CSI report is based on or associate with a CSI resource configuration (e.g., CSI-ResourceConfig). (Different CSI resource configuration is associate with different resource type.)

6.1.2. In some embodiments, each CSI report of the multiple CSI report is based on or associated with a CSI-RS resource set configuration. (Different CSI resource set configuration is associated with different resource type.)

6.1.3. In some embodiments, each CSI report of the multiple CSI report is based on or associated with one CSI-RS resource set group configuration. (Different CSI resource set group configuration is associated with different resource type. CSI resource set in one group is associated with the same resource type.)

6.1.4. In some embodiments, each CSI report of the multiple CSI report is based on or associated with a CSI-RS resource. (Different CSI-RS resource is associated with different resource type.)

6.1.5. In some embodiments, each CSI report of the multiple CSI report is based on or associated with a resource mapping. (Different resource mapping is associated with different number of ports.)

6.1.6. In some embodiments, each CSI report of the multiple CSI report is based on or associated with one CSI-RS resource group. (Different CSI-RS resource group is associated with different resource type. CSI-RS resource in one group is associated with the same resource type.)

6.1.7. In another word, if a first condition is satisfied, UE shall report CSI for each of the resource which is linked to or associated with the CSI report configuration in one CSI reporting. The resource may be one of the following: CSI resource configuration, CSI resource set, CSI resource set group, CSI resource, CSI resource group, resource mapping. Different resource is associate with different resource type.

6.2. The first condition is satisfied if one of the following events occurs:

6.2.1. UE is configured with a multiple CSI report indication,

6.2.2. UE is configured with a multiple CSI report indication and set to ‘enable’,

6.2.3. Multiple CSI configuration is configured or enabled.

6.2.4. At least one of the following signaling is configured.

6.2.4.1. a number of reports in one CSI reporting signaling,

6.2.4.2. a maximum number of a reports in one CSI reporting signaling,

6.2.4.3. a number of ports list,

6.2.4.4. a power offsets list,

6.2.4.5. a group ID list,

6.2.4.6. a resource type list,

6.2.4.7. a TCI state list,

6.2.4.8. a TCI state ID list.

6.3. In each CSI report of the multiple CSI report, at least one of the following should be reported: RI, CQI, PMI, CRI. In some embodiments, RI, CQI, PMI, CRI corresponds to different CSI report type.

6.3.1. In some embodiments, each CSI report of the multiple CSI report has same CSI report type/quantity. In some embodiments, different CSI report of the multiple CSI report has different CSI report type/quantity.

6.4. In some embodiments, if a multiple CSI report is enabled, at least one of the following CSI report quantity can be configured: ‘cri-RI-PMI-CQI’, ‘cri-RI-i1’, ‘cri-RI-CQI’, ‘cri-RI-LI-PMI-CQI’.

### VIII. Embodiment 7

7. In some embodiments, a CSI report configuration may associate with CSI resource with different resource type and multiple codebookConfig, or multiple codebook subset restriction, or multiple RI restriction. Each resource type associates with one codebookConfig, or codebook subset restriction, or RI restriction. In this embodiment, only one resource type is valid, and only the one CSI which is associated with the valid resource type is reported. The CSI which associate with other resource type are not need to be reported.

### IX. Embodiment 8

8. In some embodiments, if multiple CSI report is enabled, multiple CSI configuration should be configured at least in a BWP. The BWP is at least one of the following: the active BWP, a first BWP, a non-dormancy BWP, a default BWP.

8.1. In some embodiments, UE is not expected to switch to a BWP without multiple CSI configuration.

In some embodiments, the combined CSI report configuration is configured in a predefined BWP, where the predefined BWP is at least one of the following: first outside active time BWP, first within active time BWP, a non-dormancy BWP, a default BWP, a BWP #0, a BWP configured with a maximum bandwidth, or a power saving BWP.

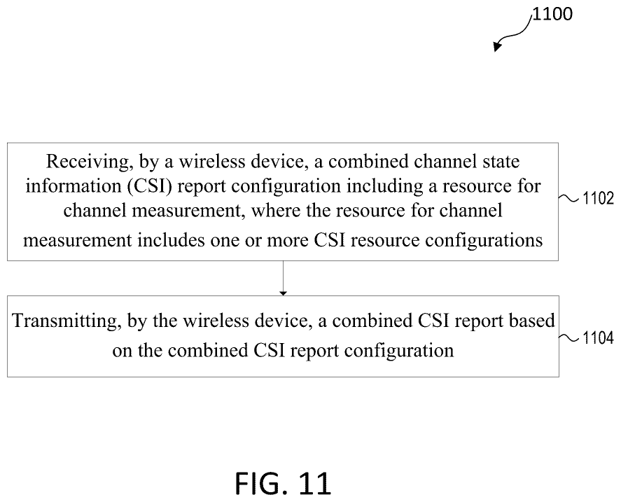

FIG. 11 is an exemplary flowchart for transmitting a combined CSI report. Operation 1102 includes receiving, by a wireless device, a combined channel state information (CSI) report configuration including a resource for channel measurement, where the resource for channel measurement includes one or more CSI resource configurations. Operation 1104 includes transmitting, by the wireless device, a combined CSI report based on the combined CSI report configuration. In some embodiments, the method can be implemented according to Embodiments 1-8. In some embodiments, performing further steps of the method can be based on a better system performance than a legacy protocol.

In some embodiments, each CSI resource configuration of the one or more CSI resource configurations is a CSI reference signal (CSI-RS) resource setting. In some embodiments, the combined CSI report includes a group of CSI reports, where each CSI resource configuration of the one or more CSI resource configurations includes one or more CSI reference signal (CSI-RS) resource sets, and where each CSI report of the group of CSI reports is based on one of the one or more CSI-RS resource sets. In some embodiments, the combined CSI report configuration includes at least one of the following: a same number of codebook configurations as a number of the one or more CSI-RS resource sets, a same number of codebook subset restrictions as the number of the one or more CSI-RS resource sets, or a same number of rank indicator (RI) restrictions as the number of the one or more CSI-RS resource sets. In some embodiments, differences among more than one CSI-RS resource set of the one or more CSI-RS resource sets are caused by different numbers of antenna ports, different power offsets, or different resource indexes.

In some embodiments, the combined CSI report includes a group of CSI reports, where each CSI resource configuration of the one or more CSI resource configurations includes one or more CSI reference signal (CSI-RS) resource sets, where each CSI-RS resource set of the one or more CSI-RS resource sets includes one or more CSI-RS resources, and where each CSI report of the group of CSI reports is based on one of or a group of the one or more CSI-RS resources. In some embodiments, the combined CSI report configuration includes at least one of the following: a same number of codebook configurations as a number of the one or more CSI-RS resources or a number of groups of the one or more CSI-RS resources, a same number of codebook subset restrictions as the number of the one or more CSI-RS resources or the number of groups of the one or more CSI-RS resources, or a same number of rank indicator (RI) restrictions as the number of the one or more CSI-RS resources or the number of groups of the one or more CSI-RS resources. In some embodiments, differences among more than one CSI-RS resource or more than one group of CSI-RS resources of the one or more CSI-RS resources are caused by different numbers of antenna ports, different power offsets, or different resource indexes. In some embodiments, a maximum number of the one or more CSI-RS resources or a maximum number of groups of the one or more CSI-RS resources is greater than 2 and less than or equal to 8. In some embodiments, a number of the one or more CSI-RS resources or a number of groups of the one or more CSI-RS resources is greater than 2 and less than or equal to 8.

In some embodiments, the combined CSI report includes a group of CSI reports, where each CSI resource configuration of the one or more CSI resource configurations includes one or more CSI reference signal (CSI-RS) resource sets, where each CSI-RS resource set of the one or more CSI-RS resource sets includes one or more CSI-RS resources, where each CSI-RS resource of the one or more CSI-RS resources includes one or more resource mappings, and where each CSI report of the group of CSI reports is based on one of or a group of the one or more resource mappings. In some embodiments, the combined CSI report configuration includes at least one of the following: a same number of codebook configurations as a number of the one or more resource mappings or a number of groups of the one or more resource mappings, a same number of codebook subset restrictions as the number of the one or more resource mappings or the number of groups of the one or more resource mappings, or a same number of rank indicator (RI) restrictions as the number of the one or more resource mappings or the number of groups of the one or more resource mappings. In some embodiments, differences among more than one resource mapping or more than one group of resource mappings of the one or more resource mappings are caused by different numbers of antenna ports, different power offsets, or different resource indexes.

In some embodiments, the combined CSI report includes a group of CSI reports, where each CSI report of the group of CSI reports is configured with a group of CSI resources, and where each CSI resource within the group of CSI resources is configured with a same number of ports or a same power offset. In some embodiments, the combined CSI report includes a CSI report and a resource indication, where the resource indication indicates at least one of the following: CSI resources associated with the CSI report, a port indication, a number of ports, a power offset, a delta of numbers of ports, or a delta of power offsets.

In some embodiments, the combined CSI report configuration further includes at least one of the following: a plurality of codebook configurations, a plurality of codebook subset restrictions, or a plurality of rank indicator (RI) restrictions. In some embodiments, a number of the plurality of codebook configurations, a number of the plurality of codebook subset restrictions, or a number of the plurality of RI restrictions is the same as a number of CSI reports in the combined CSI report. In some embodiments, the combined CSI report configuration further includes a codebook configuration, where the codebook configuration includes at least one of the following: one or more bitmaps for a codebook subset restriction, one or more bitmaps for a rank indicator (RI) restriction, a codebook subset restriction, or a RI restriction.

In some embodiments, a first CSI resource configuration of the one or more CSI resource configurations includes a first one or more CSI reference signal (CSI-RS) resources, a second CSI resource configuration of the one or more CSI resource configurations includes a second one or more CSI-RS resources, where the first one or more CSI-RS resources is a subset of the second one or more CSI-RS resources. In some embodiments, the one or more CSI resource configurations are restricted within a predefined number of slots, where the predefined number is an integer greater than or equal to 0 and less than 10.

In some embodiments, receiving the combined CSI report configuration includes receiving the combined CSI report configuration in a radio resource control (RRC) signaling, where CSI resources in a CSI resource configuration of the one or more CSI resource configurations are configured with a same number of ports or a same power offset, where the RRC signaling further includes a report parameter, and where the report parameter includes at least one of the following: a beam parameter, a number of ports list, a power offset list, a factor list, a port indication, a number of reports, or a mapping parameter.

In some embodiments, the method further includes performing, by the wireless device and based on the report parameter, a measurement of a CSI reference signal (CSI-RS) received over the CSI-RS resources in the CSI resource configuration of the one or more CSI resource configurations. In some embodiments, receiving the combined CSI report configuration includes receiving the combined CSI report configuration in a radio resource control (RRC) signaling, where the RRC signaling further includes at least one of the following: an indication to enable the combined CSI report, an indication of a minimum or maximum number of CSI reports in the combined CSI report, an indication of a number of CSI reports in the combined CSI report, a list of antenna port identifiers, a list of power offsets, a list of numbers of antenna ports, or a list of resource indexes.

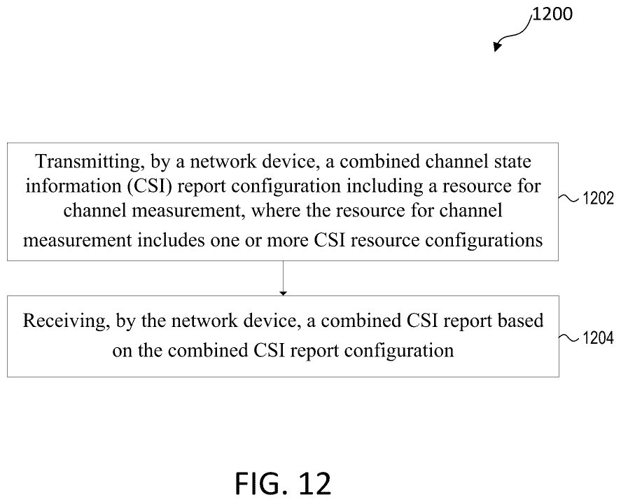

FIG. 12 is an exemplary flowchart for receiving a combined CSI report. Operation 1202 includes transmitting, by a network device, a combined channel state information (CSI) report configuration including a resource for channel measurement, where the resource for channel measurement includes one or more CSI resource configurations. Operation 1204 includes receiving, by the network device, a combined CSI report based on the combined CSI report configuration. In some embodiments, the method can be implemented according to Embodiments 1-8. In some embodiments, performing further steps of the method can be based on a better system performance than a legacy protocol.

In some embodiments, each CSI resource configuration of the one or more CSI resource configurations is a CSI reference signal (CSI-RS) resource setting. In some embodiments, the combined CSI report includes a group of CSI reports, where each CSI resource configuration of the one or more CSI resource configurations includes one or more CSI reference signal (CSI-RS) resource sets, and where each CSI report of the group of CSI reports is based on one of the one or more CSI-RS resource sets. In some embodiments, the combined CSI report configuration includes at least one of the following: a same number of codebook configurations as a number of the one or more CSI-RS resource sets, a same number of codebook subset restrictions as the number of the one or more CSI-RS resource sets, or a same number of rank indicator (RI) restrictions as the number of the one or more CSI-RS resource sets. In some embodiments, differences among more than one CSI-RS resource set of the one or more CSI-RS resource sets are caused by different numbers of antenna ports, different power offsets, or different resource indexes.

In some embodiments, the combined CSI report includes a group of CSI reports, where each CSI resource configuration of the one or more CSI resource configurations includes one or more CSI reference signal (CSI-RS) resource sets, where each CSI-RS resource set of the one or more CSI-RS resource sets includes one or more CSI-RS resources, and where each CSI report of the group of CSI reports is based on one of or a group of the one or more CSI-RS resources. In some embodiments, the combined CSI report configuration includes at least one of the following: a same number of codebook configurations as a number of the one or more CSI-RS resources or a number of groups of the one or more CSI-RS resources, a same number of codebook subset restrictions as the number of the one or more CSI-RS resources or the number of groups of the one or more CSI-RS resources, or a same number of rank indicator (RI) restrictions as the number of the one or more CSI-RS resources or the number of groups of the one or more CSI-RS resources. In some embodiments, differences among more than one CSI-RS resource or more than one group of CSI-RS resources of the one or more CSI-RS resources are caused by different numbers of antenna ports, different power offsets, or different resource indexes. In some embodiments, a maximum number of the one or more CSI-RS resources or a maximum number of groups of the one or more CSI-RS resources is greater than 2 and less than or equal to 8.

In some embodiments, the combined CSI report includes a group of CSI reports, where each CSI resource configuration of the one or more CSI resource configurations includes one or more CSI reference signal (CSI-RS) resource sets, where each CSI-RS resource set of the one or more CSI-RS resource sets includes one or more CSI-RS resources, where each CSI-RS resource of the one or more CSI-RS resources includes one or more resource mappings, and where each CSI report of the group of CSI reports is based on one of or a group of the one or more resource mappings. In some embodiments, the combined CSI report configuration includes at least one of the following: a same number of codebook configurations as a number of the one or more resource mappings or a number of groups of the one or more resource mappings, a same number of codebook subset restrictions as the number of the one or more resource mappings or the number of groups of the one or more resource mappings, or a same number of rank indicator (RI) restrictions as the number of the one or more resource mappings or the number of groups of the one or more resource mappings. In some embodiments, differences among more than one resource mapping or more than one group of resource mappings of the one or more resource mappings are caused by different numbers of antenna ports, different power offsets, or different resource indexes.

In some embodiments, the combined CSI report includes a group of CSI reports, where each CSI report of the group of CSI reports is configured with a group of CSI resources, and where each CSI resource within the group of CSI resources is configured with a same number of ports or a same power offset. In some embodiments, the combined CSI report includes a CSI report and a resource indication, where the resource indication indicates at least one of the following: CSI resources associated with the CSI report, a port indication, a number of ports, a power offset, a delta of numbers of ports, or a delta of power offsets.

In some embodiments, the combined CSI report configuration further includes at least one of the following: a plurality of codebook configurations, a plurality of codebook subset restrictions, or a plurality of rank indicator (RI) restrictions. In some embodiments, a number of the plurality of codebook configurations, a number of the plurality of codebook subset restrictions, or a number of the plurality of RI restrictions is the same as a number of CSI reports in the combined CSI report. In some embodiments, the combined CSI report configuration further includes a codebook configuration, where the codebook configuration includes at least one of the following: one or more bitmaps for a codebook subset restriction, one or more bitmaps for a rank indicator (RI) restriction, a codebook subset restriction, or a RI restriction.

In some embodiments, a first CSI resource configuration of the one or more CSI resource configurations includes a first one or more CSI reference signal (CSI-RS) resources, a second CSI resource configuration of the one or more CSI resource configurations includes a second one or more CSI-RS resources, where the first one or more CSI-RS resources is a subset of the second one or more CSI-RS resources. In some embodiments, the one or more CSI resource configurations are restricted within a predefined number of slots, where the predefined number is an integer greater than or equal to 0 and less than 10.

In some embodiments, transmitting the combined CSI report configuration includes transmitting the combined CSI report configuration in a radio resource control (RRC) signaling, where CSI resources in a CSI resource configuration of the one or more CSI resource configurations are configured with a same number of ports or a same power offset, where the RRC signaling further includes a report parameter, and where the report parameter includes at least one of the following: a beam parameter, a number of ports list, a power offset list, a factor list, a port indication, a number of reports, or a mapping parameter.

In some embodiments, transmitting the combined CSI report configuration includes transmitting the combined CSI report configuration in a radio resource control (RRC) signaling, where the RRC signaling further includes at least one of the following: an indication to enable the combined CSI report, an indication of a minimum or maximum number of CSI reports in the combined CSI report, an indication of a number of CSI reports in the combined CSI report, a list of antenna port identifiers, a list of power offsets, a list of numbers of antenna ports, or a list of resource indexes.

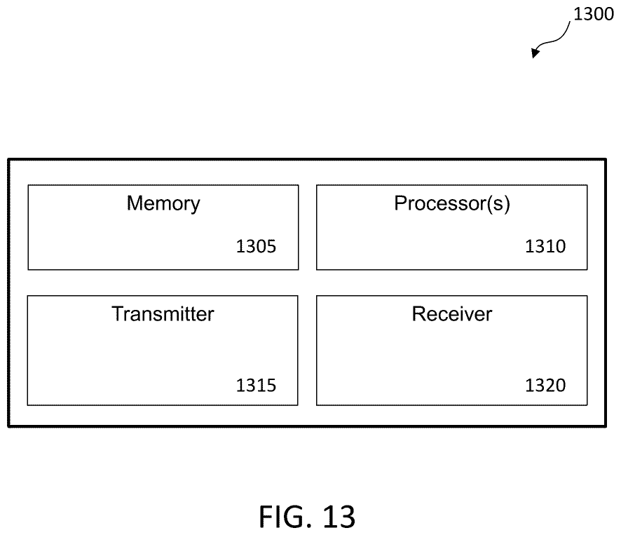

FIG. 13 shows an exemplary block diagram of a hardware platform 1300 that may be a part of a network device (e.g., base station) or a communication device (e.g., a user equipment (UE)). The hardware platform 1300 includes at least one processor 1310 and a memory 1305 having instructions stored thereupon. The instructions upon execution by the processor 1310 configure the hardware platform 1300 to perform the operations described in FIGS. 1 to 12 and in the various embodiments described in this patent document. The transmitter 1315 transmits or sends information or data to another device. For example, a network device transmitter can send a message to a user equipment. The receiver 1320 receives information or data transmitted or sent by another device. For example, a user equipment can receive a message from a network device. For example, a UE or a network device, as described in the present document, may be implemented using the hardware platform 1300.

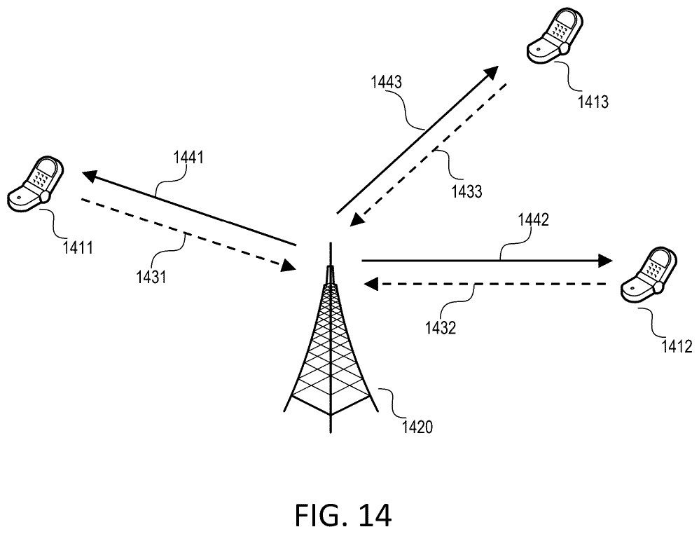

The implementations as discussed above will apply to a wireless communication. FIG. 14 shows an example of a wireless communication system (e.g., a 5G or NR cellular network) that includes a base station 1420 and one or more user equipment (UE) 1411, 1412 and 1413. In some embodiments, the UEs access the BS (e.g., the network) using a communication link to the network (sometimes called uplink direction, as depicted by dashed arrows 1431, 1432, 1433), which then enables subsequent communication (e.g., shown in the direction from the network to the UEs, sometimes called downlink direction, shown by arrows 1441, 1442, 1443) from the BS to the UEs. In some embodiments, the BS send information to the UEs (sometimes called downlink direction, as depicted by arrows 1441, 1442, 1443), which then enables subsequent communication (e.g., shown in the direction from the UEs to the BS, sometimes called uplink direction, shown by dashed arrows 1431, 1432, 1433) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 1420 depicted in FIG. 14. The UEs can also communicate with BS for CSI communications.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device, a combined channel state information (CSI) report configuration comprising a resource for channel measurement, wherein the resource for channel measurement comprises one or more CSI resource configurations; and
transmitting, by the wireless device, a combined CSI report based on the combined CSI report configuration,
wherein the combined CSI report configuration further comprises a plurality of codebook configurations, and wherein each codebook configuration comprises at least one of the following:
a codebook subset restriction and a rank indicator (RI) restriction.

2. The method of claim 1, wherein the receiving the combined CSI report configuration comprises receiving the combined CSI report configuration in a radio resource control (RRC) signaling, wherein CSI resources in a CSI resource configuration of the one or more CSI resource configurations are configured with a same number of ports, wherein the RRC signaling further comprises a report parameter, and wherein the report parameter comprises a port indication list or a number of ports list.

3. The method of claim 1, wherein the receiving the combined CSI report configuration comprises receiving the combined CSI report configuration in a radio resource control (RRC) signaling, wherein the RRC signaling comprises a report parameter, and wherein the report parameter comprises a power offset list.

4. The method of claim 2, wherein the RRC signaling further comprises a resource type list, wherein the resource type list includes more than one index, and wherein each entry in the resource type list is associated with a codebook configuration.

5. The method of claim 1, wherein the combined CSI report comprises one or more CSI reports, and wherein multiple CSIs are reported for different resource types.

6. The method of claim 2, wherein the report parameter is used to select parts of CSI-RS ports from a CSI-RS resource configured with a first number of ports.

7. The method of claim 6, wherein a second number of ports are selected from the first number of ports based on a signaling.

8. The method of claim 7, wherein the signaling indicates a bitmap, and wherein a length of the bitmap is same as the first number of ports.

9. The method of claim 8, wherein each bit in the bitmap corresponds to a port index, and wherein the bit is “0” when a corresponding port is not selected, and the bit is “1” when the corresponding port is selected.

10. The method of claim 1, wherein the combined CSI report comprises one or more CSI reports, and each CSI of the one or more CSI reports has a same CSI report quantity.

11. The method of claim 10, wherein the same CSI report quantity is at least one of: “cri-RI-PMI-CQI,” “cri-RI-i1,” “cri-RI-CQI,” or “cri-RI-LI-PMI-CQI.”

12. A method of wireless communication, comprising:
transmitting, by a network device, a combined channel state information (CSI) report configuration comprising a resource for channel measurement, wherein the resource for channel measurement comprises one or more CSI resource configurations; and
receiving, by the network device, a combined CSI report based on the combined CSI report configuration,
wherein the combined CSI report configuration further comprises a plurality of codebook configurations, and wherein each codebook configuration comprises at least one of the following:
a codebook subset restrictions and a rank indicator (RI) restriction.

13. The method of claim 12, wherein the transmitting the combined CSI report configuration comprises transmitting the combined CSI report configuration in a radio resource control (RRC) signaling, wherein CSI resources in a CSI resource configuration of the one or more CSI resource configurations are configured with a same number of ports, wherein the RRC signaling further comprises a report parameter, and wherein the report parameter comprises a port indication list or a number of ports list.

14. The method of claim 13, wherein the RRC signaling further comprises a resource type list, wherein the resource type list includes more than one index, and wherein each entry in the resource type list is associated with a codebook configuration.

15. The method of claim 12, wherein the combined CSI report comprises one or more CSI reports, and wherein multiple CSIs are reported for different resource types.

16. The method of claim 13, wherein the report parameter is used to select parts of CSI-RS ports from a CSI-RS resource configured with a first number of ports.

17. The method of claim 16, wherein a second number of ports are selected from the first number of ports based on a signaling, wherein the signaling indicates a bitmap, wherein a length of the bitmap is same as the first number of ports, wherein each bit in the bitmap corresponds to a port index, and wherein the bit is “0” when a corresponding port is not selected, and the bit is “1” when the corresponding port is selected.

18. An apparatus for wireless communication, comprising one or more processors, wherein the one or more processors are configured to implement a method comprising:
receiving a combined channel state information (CSI) report configuration comprising a resource for channel measurement, wherein the resource for channel measurement comprises one or more CSI resource configurations; and
transmitting a combined CSI report based on the combined CSI report configuration,
wherein the combined CSI report configuration further comprises a plurality of codebook configurations, and wherein each codebook configuration comprises at least one of the following:
a codebook subset restriction and a rank indicator (RI) restriction.

19. The apparatus of claim 18, wherein the receiving the combined CSI report configuration comprises receiving the combined CSI report configuration in a radio resource control (RRC) signaling, wherein CSI resources in a CSI resource configuration of the one or more CSI resource configurations are configured with a same number of ports, wherein the RRC signaling further comprises a report parameter, and wherein the report parameter comprises a port indication list or a number of ports list.

20. The apparatus of claim 18, wherein the receiving the combined CSI report configuration comprises receiving the combined CSI report configuration in a radio resource control (RRC) signaling, wherein the RRC signaling comprises a report parameter, and wherein the report parameter comprises a power offset list.
